(19) United States
(12) Patent Application Publication
(10) Pub. No.: US 2020/0278845 A1
(43) Pub. Date: Sep. 3, 2020

(54) METHOD AND SYSTEM FOR DEVELOPMENT OF WEB SOFTWARE APPLICATION

(71) Applicant: Barak Ravid, Or Yehuda (IL)

(72) Inventor: Barak Ravid, Or Yehuda (IL)

(21) Appl. No.: 16/800,527

(22) Filed: Feb. 25, 2020

Related U.S. Application Data
(60) Provisional application No. 62/811,588, filed on Feb. 28, 2019.

(51) Int. Cl. G06F 8/38; G06F 8/70

(52) U.S. Cl. CPC G06F 8/38; G06F 8/70

(57) ABSTRACT

A system for creating a software application by unified development of both the client side and the backend side, the system comprises: a server for creating and storing a plurality of self-contained software complexes, each software complex defines a user interface element configured to be rendered at a client device; a processor configured to execute code instructions stored in the self-contained software complex, and when executed by the processor, the instructions cause the processor to: activate at least a subset of the plurality of complexes, the activating including sending to a remote client device data from the complexes, the data required for rendering the user interface elements, and initiating a series of life-cycle stage of the complex; receive from the client device data obtained by the rendered user interface elements; and update the complexes' life-cycle stages at the server, based on the received data.

### BACKGROUND

A web application is a software application that at least partially runs on a remote server, usually with a user interface rendered by a web browser on a client device. In most cases, web browsers are used to access web applications, over a network, such as the Internet. Some web applications are used in intranets, in companies and schools, for example.

Architecture of known development methods of web applications are usually divided to three layers: application logic, server side and client side. The server is a mediator layer that communicates with the client side and the application logic. The application logic is the logic of the provided application product or service itself. The client side or client application usually run on a client computer device such as a desktop computer, a mobile device, a laptop, a smartphone, etc. Having these three layers usually requires corresponding three types of software professionals, that develop the logic, server side and client side, respectively. The three layers usually require different software development expertise, languages and/or tools. Therefore, a large portion of the time and money invested in development is dedicated to coordination between the layers and the respective development people.

Existing web application interfaces are usually composed of many elements of display and interaction with users. Many times, it is required to have client-side data storage, state management and communication with the server side. The more complicated the application becomes, the greater the complexity of the interface. In many cases data or state are stored and shared between components, or components are dependent on data stored by and for other components. With time and progression of development, adding new features or elements to the interface becomes more complicated. This is caused by the need to test influence on existing interface components with their data storage, state management and communication with server for any new component added to the interface.

There are various libraries such as Facebook React, Redux, or Facebook GraphQL which better organize and increase the granularity of the code base and decrease the unstructured and difficult-to-maintain source code with regards to division to components with their data storage, and enforce more order as to how and when these are displayed and refreshed with new data. Disciplined development teams can enforce standards as to how the structure, data storage, state management are defined and developed. However, replacing a team member or making changes after a long period of time raises the probability of chaos and difficulty to add components once knowledge is lost.

In practice, development is done on three different layers with a shared goal of having everything eventually work together. But there are no inter-dependencies and/or inter constraints, during development itself, except for when the system is eventually tested for all components working together and properly communicating with each other through the layers. Implementing transfer of data from server to client and back, or implementing the update of the interface state with new or updated data are a repeating and tedious development processes that requires much work. There are various software libraries that add order and shorten the work required. These accomplish various development and runtime functions such as connecting the data transferred and the interface update process, or store information on the client side. The problem with this approach is that in many cases the data transfer, storage and interface update processes are not forced to be defined only in the context of the component, but are developed in parallel to eventually work together while serving different components.

Additionally, almost every interface needs to interact with the application layer or some third-party service to get information, issue commands or execute long term processing. Server-side processing can be short as few seconds or as long as few months.

A multistage work process involves several changing application states for executing commands or passing information to users. For example, a multistage registration process to a new service such as a dating site or a car insurance. Another example is a login process where the login form is replaced with logged on user details upon a successful login, and a fail in the login process will either leave the user at login form or go to an “access denied” page. Many developers implement such process by using separate components and activating them in sequence, while using certain software solutions ad hoc to maintain state for process.

Usually, a user interface is developed to enable the user to view information, provide information and issue commands. In many development frameworks, or application generators, may it be for web development or desktop application or mobile development, the developer is exposed to many concepts that are technical in nature and arise from the programming necessities of the specific platform. For example—in application generator tools or environments like Delphi or PHPMaker or client-side frameworks like Facebook React—the developer can implement various events to achieve the task of displaying information from database. There are events such as onDatabaseConnection, onBeforeShow, onBeforeInsert, onAfterInsert, ComponentWillMount, ComponentWillUnmount, ComponentWillReceiveProps, etc. When planning software to be activated or integrated with a user interface, the question should be “at what stage should this be activated”, rather than “what software event would best fit this use case”. But in practice the latter is what happens in many cases. Using a multiple events model for platform-related technical events creates complexity and inconsistency between developers and forces the business logic to be twisted to fit it into these conditions.

Technical requirements of the client/server platform specific development options have spurred a variety of tools that try to solve specific problems such as how to store data and state of the application, and how is the easiest way to display and update the user interface with various design features. Such tools include, for example, React-Redux, Material-UI, backbone.js, Angular, GraphQL, etc. There are frequent releases of new versions of development tools, forcing developers to migrate their code and waste many hours. For example, when a new version of a certain library with breaking changes is released, any project using this library must be updated to make required changes, or remain with older versions, which may be, for example, incompatible with newer systems. Accordingly, in some cases, business owners are forced to choose between spending a lot of money on fresh development, or remaining with what appears to be an obsolete product, and not because the solution provided by the product isn't good, but because the development environment has changed.

### SUMMARY

An aspect of some embodiments of the present disclosure provides a system for creating a software application by unified development of both the client side and the backend side, the system comprises: a server for creating and storing a plurality of self-contained software complexes, each software complex defines a user interface element configured to be rendered at a client device; a processor configured to execute code instructions stored in the self-contained software complex, and when executed by the processor, the instructions cause the processor to: activate at least a subset of the plurality of complexes, the activating including sending to a remote client device data from the complexes, the data required for rendering the user interface elements, and initiating a series of life-cycle stage of the complex; receive from the client device data obtained by the rendered user interface elements; and update the complexes' life-cycle stages at the server, based on the received data.

Optionally, each complex controls its own dataset stored in a storage controlled by the server, and the processor is configured to update the complexes' datasets at the server based on the received data.

Optionally, the processor is configured to execute tasks by a business logic based on the data received from the client device.

Optionally, at least one of the plurality of complexes is a parent complex including definitions for creation of at least one child complexes.

Optionally, the child complexes inherit the life-cycle stage of the parent complex, and change their life-cycle stage according to changes in the life-cycle stage of the parent complex, by a message transmitted to the child complexes via a coordination component in the server.

Optionally, at least a subset of the plurality of complexes constitutes a complex chain, wherein the complex chain determines the order of execution of the complexes in the chain.

Optionally, of the complexes in a certain chain, only one is an active complex in a certain moment, wherein an active complex is a complex during the time the corresponding user interface element is rendered at a client device.

Optionally, once activating a complex, after initiating, the processor is configured to: load data about the complex from a coordination component and send the data to the client device; send to the client device an indication that the loading stage is completed; switch the complex to a rendering stage that enables the client device to render the corresponding user interface element based on the sent data; and receive from the client device information gathered during the rendering stage by the corresponding user interface element.

Optionally, the processor is configured to deactivate the complex in response to the received information, wherein the data of the complex is kept, and the deactivated complex is re-activatable.

Optionally, the processor is configured to terminate the complex in response to the received information, and to send an indication to the client device about the termination.

Optionally, the processor is configured to: initiate execution of a task according to the information gathered during the rendering stage; refresh data of the complex based on the executed task; send the refreshed data to the client device; send to the client device an indication that the loading stage is completed; switch the complex to a rendering stage that enables the client device to render the corresponding user interface element based on the sent data; and receive from the client device information gathered during the rendering stage by the corresponding user interface element.

Optionally, the processor is configured to: deactivate the current active complex in case the task required transition to another complex; and perform transition to another complex.

Optionally, the processor is configured to store in a coordination component a message to a recipient complex and to transmit the message to the recipient complex, further to information received during execution of a sender complex, wherein the recipient complex is identified by a complex tree the recipient complex is included in or the location of the recipient complex in a hierarchy of the complex tree.

Optionally, the processor is configured to: receive from the client device a request from a user included in the received obtained data from the rendered user interface element; perform a task based on the request; provide the client device with updated information about active complexes required for update of the rendered user interface components by the client device.

### BRIEF DESCRIPTION OF THE DRAWINGS

Some non-limiting exemplary embodiments or features of the disclosed subject matter are illustrated in the following drawings.

In the drawings:

FIG. 1 is a schematic illustration of a system for software application development, according to some embodiments of the present invention;

FIGS. 2A and 2B are schematic illustrations of a web application structure including elements required for developing a web application and the portions made more efficient according to some embodiments of the present invention;

FIG. 3 is a schematic illustration of a web application structure, developed in a unified layer according to some embodiments of the present invention;

FIG. 4 is a schematic illustration of a method for managing operations of complexes 30, according to some embodiments of the present invention;

FIG. 5 is a schematic illustration of an exemplary operation process for lifecycle of a single complex of a web application structure, according to some embodiments of the present invention;

FIG. 6 is a schematic illustration of a process for execution of a task, for example following a command received from a client application component, for example further to a command and/or event made by a client user, and/or a task required by the business logic, according to some embodiments of the present invention;

FIG. 7 is a schematic illustration of a process for transition between complexes according to some embodiments of the present invention;

FIG. 8 is a schematic table of complex trees and complex transition steps, according to some embodiments of the present disclosure; and

FIG. 9 is a schematic illustration of a process for processing of client user requests received by user interface components created by complexes and rendered by the client application component, according to some embodiments of the present invention.

With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

### DETAILED DESCRIPTION

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

Some embodiments of the present disclosure provide a method and system for web application software development. The provided method and system integrate at least the client-side development layer with the server-side development layer, thus making the web-application development and maintenance more organized and saving time and money.

It will be appreciated that throughout the present disclosure, a “web application” may refer to any web and/or mobile software application that requires cooperation between an application server and a client device, wherein the application server may execute the business logic, receive data and/or commands from the client device, and process the data and/or commands based on server-side instructions.

Additionally, it will be appreciated that throughout the present disclosure, a “business logic” is some code that defines software processes to be run, also called herein “tasks”, and database structure, calculations and/or commands needed to carry out those processes, for example based on values inputted by a client user interface at a client device. For example, a server may receive a value, identify that execution of a task is required, and trigger the business logic to perform the task. In some cases, a business logic process produces a response that may be communicated to a client device by the server.

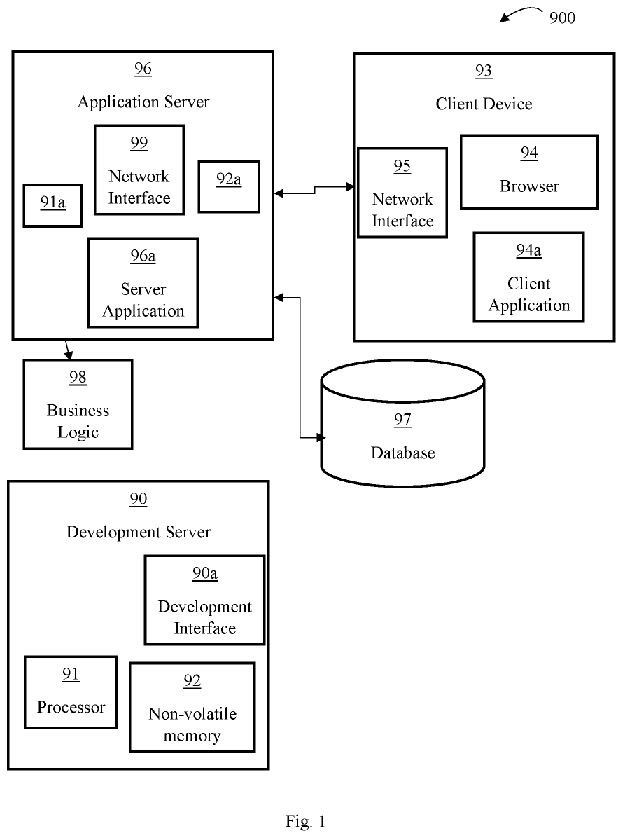

Reference is now made to FIG. 1, which is a schematic illustration of a system 900 for software application development, according to some embodiments of the present invention. System 900 may include a development server 90 and at least one processor 91 and at least one hardware memory 92. Memory 92 may include a tangible non-transitory computer readable storage medium (or media) configured for storing computer readable program instructions thereon for causing at least one processor 91 to carry out aspects of the present disclosure. According to some embodiments of the present invention, development server 90 includes a development interface 90a, by which a developer user can enter code instructions and construct a software application, as described in more detail herein. For example, by development interface 90a, a developer user constructs at least a server application component 96a and a client application component 94a, as described in more detail herein. System 900 may further include a database 97, for example a non-volatile storage, the data structure of which may be determined by a developer user by development interface 90a.

Further, system 900 may include an application server 96. Application server 96 is configured for carrying out a set of instructions received from development server 90 and stored in/for application server 96. Application server 96 may further communicate with a client device(s) 93, for example receive data and/or commands from client device 93, process the received data and/or commands according to instructions stored in server application component 96a and/or store the received data in database 97. Application server may communicate data and/or commands to a business logic 98 and/or provide instructions to execute tasks by business logic 98 based on the received data and/or commands According to some embodiments, client device 93 includes application client component 94a, which may include a client user interface, by which a client user may receive and send data and commands. In some embodiments, client device 93 renders application client component 94a by a web browser 94 included in client device 93. Application server 96 and client device 93 may communicate by network interfaces 99 and 93, respectively, for example by wired, wireless and/or cellular network connection such as internet and/or intranet connection.

Application server 96 may also communicate with other parties such as third-party application programming interfaces (API) and/or other databases.

It will be appreciated that application server 96 may include at least one hardware processor 91a and a hardware memory device 92a, configured to store, control, execute and/or coordinate between server application component 96a, business logic 98 and/or network interface 99, and/or to collaborate with processor 91. In some embodiments, application server 96 is integral with development server 90. For example, at least one processor 91 and memory device 92 are configured to store, control, execute and/or coordinate between server application component 96a, business logic 98 and/or network interface 99.

In some embodiments of the present invention, development server 90 integrates the development of at least server application component 96a and client application component 94a, as described in more detail herein below. That is, system 900 may enable creation of a software application by unified development of both the client side and the backend side. Server 90 and/or server 96 may be configured for creating and storing a plurality of self-contained software complexes, each software complex defines a user interface element configured to be rendered at client device 93. At least one processor 91 and/or 91a may be configured to execute code instructions stored in the self-contained software complex, and when executed by the processor, the instructions cause the processor to: activate at least a subset of the plurality of complexes, the activating including sending to remote client device 93 data from the complexes, the data required for rendering the user interface elements, and initiating a series of life-cycle stage of the complex; receive from the client device data obtained by the rendered user interface elements; and update the complexes' life-cycle stages at server 96 and/or 90, based on the received data.

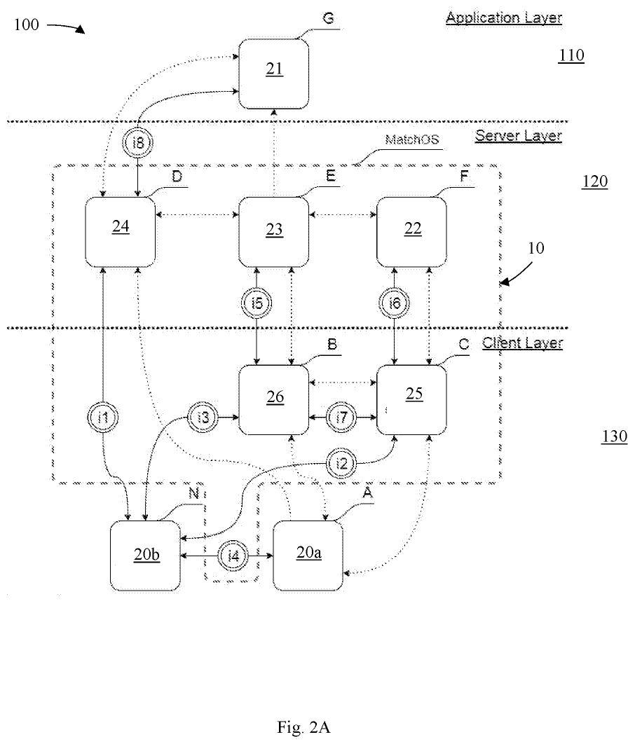

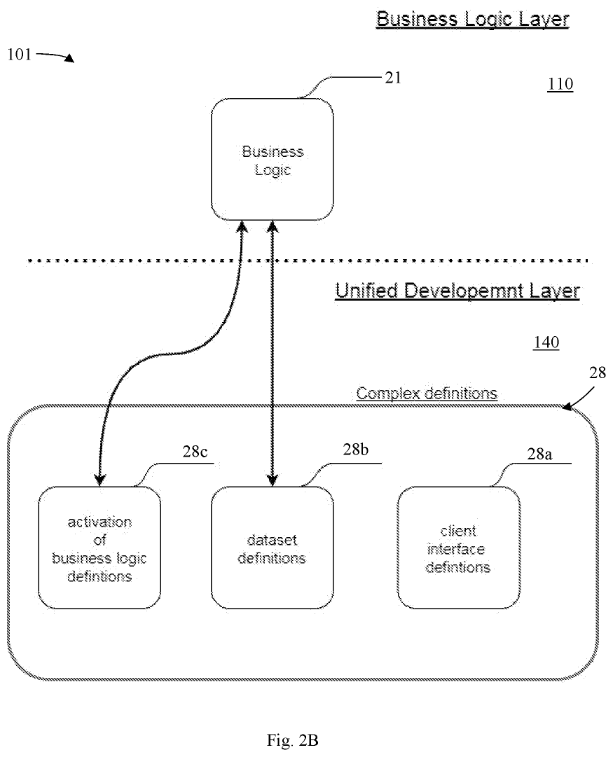

Reference is now made to FIGS. 2A and 2B, which are schematic illustrations of a standard web application development environment structure 100 and a more efficient development structure 101, according to some embodiments of the present invention. Structure 100 includes elements required for developing a web application in existing development environments. Structure 100 includes separate application development layer 110, server development layer 120 and client development layer 130. In some embodiments of the present invention, the elements surrounded by a dashed line 10 are replaced by a more efficient development environment, for example a unified development layer 140 shown in FIG. 2B.

As shown in FIG. 2A, at some development stage, a user-interface component 20a may be created in development environment structure 100 by developing corresponding runtime components in client layer 130 and server layer 120. At some development stage, another user-interface component 20b may be created in development environment structure 100 by developing corresponding runtime components in client layer 130 and server layer 120. The labeled double-lined circles in FIG. 2A represent development work required to implement adjustments to functionalities, components, relations between components and/or communication between components, required in order to add component 20b to the web application being developed. The arrows in FIG. 2A may represent directions of dataflow, influence and/or relations of and/or between runtime components. As described in more detail herein below, some embodiments of the present invention provide a more efficient development process and/or platform that abolishes the need for at least some of these implementation adjustments.

Application layer 110 may include business logic component 21, which may be included in or parallel to business logic 98 shown in FIG. 1. Server layer 120 may include a server-side state management runtime component 22, a server-side input/output endpoint runtime component 23, and/or a server-side task processing runtime component 24. The server layer runtime components 22, 23 and/or 24 may be developed by a server-side (or “backend”) developer. Server-side task processing runtime component 24 may be configured to activate and/or manage long-term, business logic and/or third-party processing. For example, server-side processing runtime component 24 receives commands from a client user, process the received commands and/or activates business logic 21 in response. For example, server-side processing runtime component 24 implements a mechanism for activating long term processing. Server-side input/output endpoint runtime component 23 may function as an endpoint for communications from the client-side to send data and/or commands to the server-side and for the server-side to send data and/or commands to the client-side. Server-side state management runtime component 22 may manage a server-side state, for example with relation to the client-side.

Client layer 130 may include a client-side state management runtime component 25 and/or a client-side data storage runtime component 26. The client layer runtime components 25 and/or 26 may be developed by a client-side (or “frontend”) developer. Client-side state management runtime component 25 may store and/or manage a state of the client-side, and/or may be implemented in practice as part of data storage runtime component 26. Client-side data storage runtime component 26 may store any data to be used by the client-side. For example, client-side data storage runtime component 26 stores data received from the server-side, for example data to be displayed by user-interface component(s), such as user-interface components 20a and 20b. For example, client-side data storage runtime component 26 stores data received from/entered by a client user as input, for example by using user-interface component(s) at the client-side.

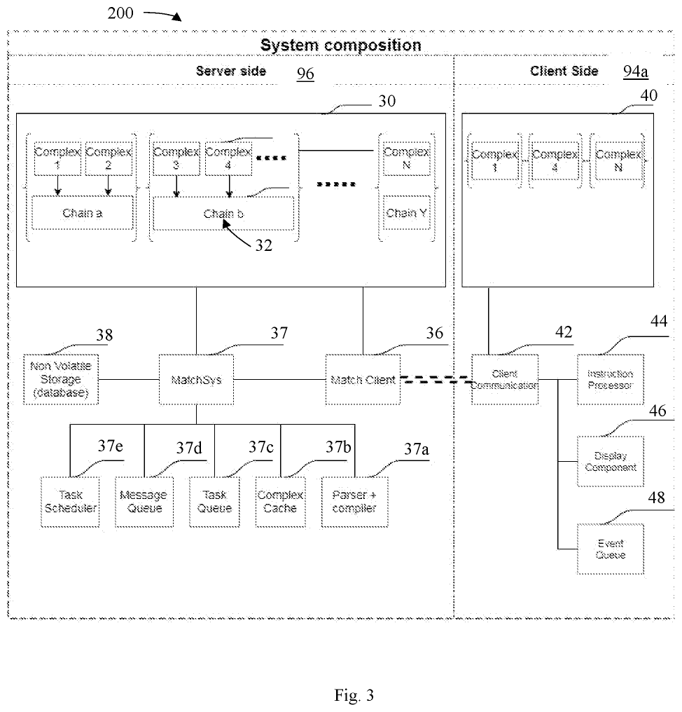

The functionalities of at least some of the server-side and client-side runtime components may be included in, controlled by and/or replaced by other functionalities implemented in complex definitions 28 shown in FIG. 2B, according to some embodiments of the present invention, and/or as described in more detail herein below with reference to FIGS. 3-8. For example, in a unified development layer 140, a developer may create a complex 28 that defines a user interface component and/or includes data, definitions and functions of the user interface component, for example by development server 90 shown in FIG. 1. For example, complex 28 may include client interface definitions 28a, dataset definitions 28b and business logic activation definitions 28c. In order to add another user interface component, a corresponding additional complex may be created that includes the required definitions, including relationship with other complexes. As described in more detail below, server application component 96a may activate relevant complexes for rendering by client application component 94a, receive client input, and update the complexes and/or which complexes are activated, for example based on the input and/or task products provided by business logic component 98.

Reference is now made to FIG. 3, which is a schematic illustration of a web application structure 200, developed by a unified development layer, according to some embodiments of the present invention. Application structure 200 may be created by a developer using development server 90 and/or development interface 90a. Application structure 200 may include client application component 94a and server application component 96a. server application component 96a may be installed in application server 96. In some embodiments of the present invention, development server 90 and/or development interface 90a store, process and/or enable construction and/or implementation of self-contained software components, herein referred to as “complexes” 30, that unify the client-side and server-side layers to a single layer from a development standpoint. As described in more detail herein, for each of the unifying complexes 30, a developer user can write code into development server 90 and/or development interface 90a for one layer using a unifying semantic programming language that is provided by some embodiments of the present disclosure. The unifying programming language defines construction and functionality of unifying complexes 30 for both the client and server side. Thus, the client and server operations are developed together in one development layer, with clear distinction from business logic 98. Therefore, the provided system and method reduce development time and complexity.

For example, each complex 30 defines a user-interface component to be rendered by client application component 94a. For example, complex 30 may include code, instructions, definitions, data and/or any other information required to render a user-interface component by client application component 94a. Throughout the present description, a user-interface component may refer to any suitable interface component such as, for example, a form, a menu, a button, an input box, a table if items, a news display, an article, an auto complete search box, etc.

Application server 96 may control and/or store the state, data, functionality and/or may store a virtual image of client application component 94a in a non-transitory memory and/or a non-volatile storage, such as database 97. According to some embodiments, client application component 94a is subordinated to application server 96 and/or may make limited decisions locally at client device 93 regarding display and/or client user interaction such that it does not impact functionality and state of the components and/or not override decisions of the application server.

Some embodiments of the present disclosure enable additional platform-specific development at the client side, for example for flexibility, in addition to the unified development of application structure 200.

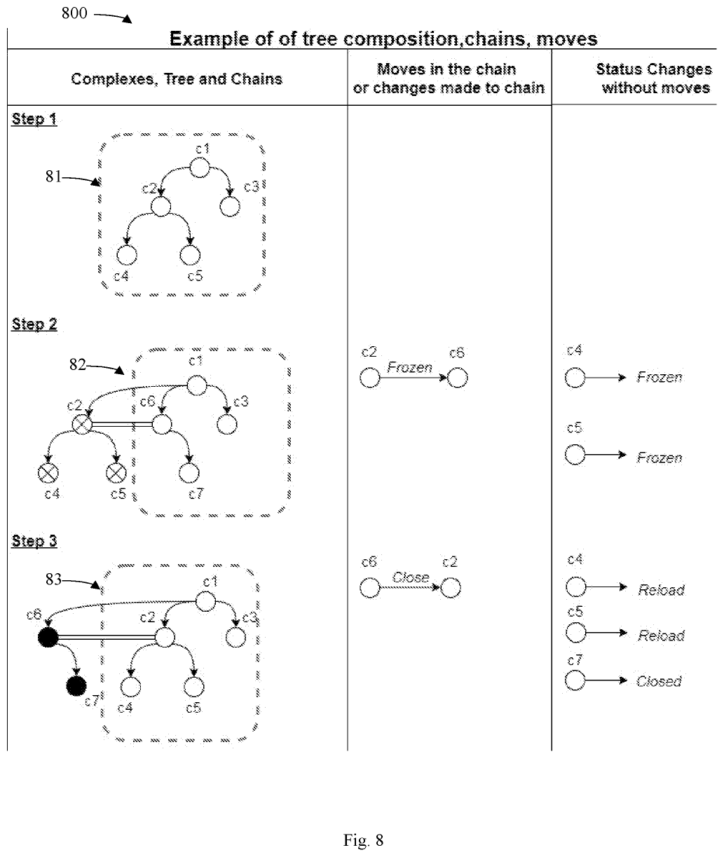

According to some embodiments of the present disclosure, development server 90 and/or interface 90a is configured for creation, for example by a developer user, a collection of mutually independent complexes 30, for example N complexes complex 1 to complex N shown in FIG. 3. According to some embodiments, a complex 30 is self-contained and/or have its own dataset and/or state management, may be communicated between server application 96a and client application 94a independently from other complexes 30, and/or may communicate data and/or instructions from server application 96a to client application 94a and vice versa, independently from other complexes 30. Development server 90 and/or interface 90a may be configured to include and/or enable construction of a structure of decoupled complexes, herein referred to as a “complex tree”, as described in more detail with reference to FIG. 8. Web application structure 200, developed according to some embodiments of the present invention, may include any number of complexes 30, for example in one or more complex trees, and/or any number of complexes may be added or removed without effecting the stability or harming the functionality of other components of web application structure 200.

As described in more detail herein below, in some embodiments of the present invention, a complex 30 may include, refer to, have access to and/or control its own dataset specific to the complex, herein referred to as a “complex dataset”. A complex dataset may include information used for displaying the corresponding user-interface component. For example, two complexes 30 may each refer to different datasets, although the data source and/or the content of the datasets may be the same. For example, each dataset may include a different portion, configuration and/or order of data stored in a storage. Data-related operations such as, for example, updating of the dataset, transferal of data from or to the complex dataset, transferal of data between the complex dataset and business logic 98, transferal of datasets between client application component 94a and server application component 96a, storage of data from the complex dataset by the client application component 94a and updating of client application component 94a and/or server application component 96a based on data from the dataset, may be performed automatically, for example at runtime. For example, in some embodiments, the complex dataset is defined as a runtime property in the provided unifying programming language, for example as a system variable whose state can be tested, rather than implementation of the runtime property in the component level. Thus, for example, the need for certain client-side libraries (such as React-Redux), or programming language methodology such as binding used for implementing automatic update of interface component from changes to data stored in client side may be eliminated. Since client-side and server-side are developed at the same unified layer, the need to implement synchronization and/or coordination between the layers by the developer may be eliminated.

For example, a complex 30 may store its own client-side dataset according to predetermined rules. This allows for optimization of usage of storage, since the need for any set of data is predictable and lack of need of data is predictable. In some embodiments, the datasets are stored for their respective complexes in the same manner, and thus, for example, it is possible to set a global policy for managing client-side storage, for example as to when and how to retain data. For example, how to retain frequently used data and/or when to discard data for a low-priority, unused, deactivated and/or removed complex.

As further described in more detail herein below, according to some embodiments of the present invention, application structure 200 uses a task mechanism that activates processes across the server application component 96a and client application component 94a by a unifying complex 30. The provided task mechanism may activate a process of an application logic for any arbitrary length of time. In some embodiments of the present invention, the task mechanism deals with errors, and synchronizing tasks and resources between tasks.

In some embodiments, a complex 30 belongs to a certain series or group of complexes, herein referred to as a complex chain 32. The complex chain determines the work process, including the transitions made from one complex to another.

Some embodiments of the present invention provide a graphical programming interface to display information, obtain information, issue commands and activate software on those commands During development, a developer may define a structure of components, including what data is displayed and from where it is taken and how. This structure may respond to various types of events such as commands and/or data received from a user or a user activity via a user interface. As described in detail herein, some embodiments of the present invention make the development process of a web application more efficient.

According to some embodiments of the present invention, each complex 30 is a link in a chain of complexes, herein referred to as a complex chain 32. An application structure 200 may include multiple chains 32, such as chains a to Y shown in FIG. 3. A chain 32 may include multiple complexes 30. In some embodiments, a chain 32 is embedded with and/or related to an order of execution of complexes 30 included in this chain 32, for example according to an order of creation of the complexes 30 or another determined execution order embedded in and/or stored in related to chain 32, for example by a developer user and/or automatically by development interface 90a. Accordingly, in some embodiments, complexes 30 included in a certain chain 32 are executed according to the stored and/or embedded order. In some embodiments, only one of the complexes 30 included in a certain chain 32 is an active complex 30 in a certain moment. An active complex 30 is a complex 30 during its execution and/or while it is visible, usable and/or interactive to a client user by client application component 94a. For example, multiple complexes 30 may be active concurrently, each from a different chain 32. Chain 32 that has an active complex 30 is referred to herein as an active chain 32. Chain 32 may be regarded as active if server application 96a defines it as an active chain and/or it includes an active complex 30. Server 96 may hold a list of currently active chains. The active complexes 30 of the active chains 32 constitute a momentary user interface rendered by client application component 94a during the respective period of time. For example, a chain a may include complex 1 and complex 2. A chain b may include complex 3, complex 4 and possibly more complexes. At a certain moment, complex 4 of chain b may be active. As described in more detail herein, each chain 32 may have a unique identifier. For example, various components of structure 200 may identify a complex chain and/or the complexes included in this complex chain by its identifier.

According to some embodiments of the present invention, server application component 96a includes client endpoint component 36. Client endpoint component 36 may be an entry point for client requests, for example requests received from client application component 94a, and/or may initiate an activity based on a client request. Client endpoint component 36 may transmit a request to a coordination component 37 (described herein below) and/or to a complex/complex tree.

Coordination component 37, according to some embodiments, may coordinate between various components of structure 200. For example, coordination component 37 may enter complexes 30 into their respective chains 32, coordinate and/or synchronize activation of multiple complexes 30 of different chains 32, provide order of execution of the complexes 30 to the respective chains 32, and/or retrieve data from and/or store data in a non-volatile storage 38, for example data regrading a state of a component of application structure 200 or any other suitable data. Non-volatile storage 38 may be included in database 97 and/or may store long term information that can be retained by components of application structure 200, for example by coordination component 37.

Non-volatile storage 38 may be included in and/or controlled by development server 90 and/or application server 96. Non-volatile storage 38 may store the state of various components of application structure 200, including, for example the states of both the server application component and of the client application component. It will be appreciated that a component state, throughout the present description, means a component's dynamic data and/or data that determines the component's behavior at a certain period of time. Non-volatile storage 38 may store information about states, complex life-cycle stages and/or stage changes and/or definitions of various components of application structure 200.

Coordination component 37 may control and/or include coordination sub-components such as a parser/compiler component 37a, a complex cache 37b, a task queue 37c, a message queue 37d, and/or a task scheduler 37e. Parser/compiler component 37a may parse and/or compile code, for example at development time or runtime, entered to development server 90 by a developer user, for example via development interface 90a. Parser/compiler component 37a may parse and/or compile code during runtime and/or during development time as required by server 96 and/or development server 90. For example, parser/compiler 37a may compile portions of code relevant for client application component 94a. Coordination component 37 may sent the compiled code to client application component 94a, during runtime and/or during development time as required by server 96 and/or development server 90. Complex cache 37b may store information, for example volatile information, relevant to runtime operations of complexes 30. Task queue 37c may store commands to be executed in long term processing, for example by the application logic. Message queue 37d may perform communication between multiple active complexes 30 and/or between Coordination component 37 to an active complex 30. Task scheduler 37e may initiate execution of commands from task queue 37c.

Client application component 94a may include client-side data storage component 40. Client data storage 40 may store active complex information required for rendering of active complexes. For example, client data storage 40 may store data, definitions, code, instructions and/or states of active complexes 30. For example, in case complexes complex 1 (of chain a), complex 4 (of chain b) and complex N (of chain Y) are active concurrently, the information required for rendering of these active complexes is stored in client data storage 40. The information is stored in client data storage 40 for at least as long as these complexes are active or as long as this information is required by client application component 94a.

Client application component 94a may also include a client communication component 42, an instruction processor 44, a display component 46 and/or event queue 48. Client communication component 42 may be configured to manage all communications from client application component 94a to application server 96. For example, client communication component 42 may upload information to application server 96, download information from application server 96, send commands to application server 96 and/or receive commands from application server 96.

Instruction processor 44 may process code instructions, which may include instructions, definitions and/or any other suitable processable information generated by development server 90, and/or may implement the definitions or information and/or execute the instructions by client application component 94a, for example for displaying information, responding to client user activity, and/or otherwise processing active complexes.

Display component 46 may display a user interface according to definitions from client data storage 40 for each active complex. Event queue 48 may store a list of events and/or actions made by a client user, e.g. a user of client device 93.

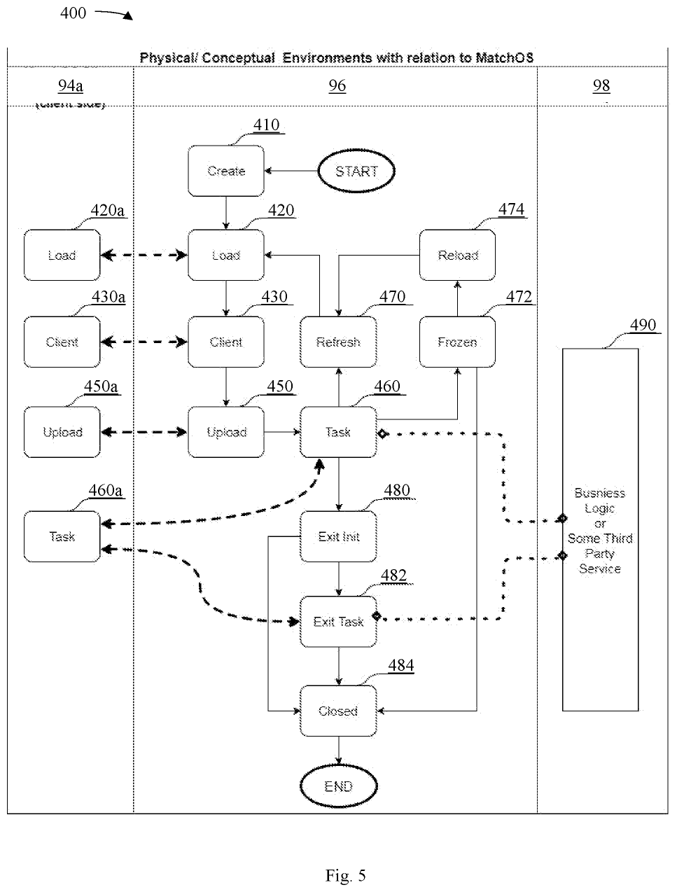

According to some embodiments of the present invention, server application component 96a may be configured to execute an operation management method for managing operations of complexes 30. For example, the operation management method controls activation and/or life-cycle of active complexes 30 and/or transition between complexes 30. A life-cycle of an active complex 30 may include multiple defined stages. The operation management method may manage the transition between the stages. Each complex stage includes its own unique pre-defined operations. For example, each life-cycle stage may include a set of operations defined for this stage. Such operations may include, for example, setup, initiation, refreshing, loading of messages, processing of client input, uploading from client to server, performing tasks, exiting, closing a complex, transitioning to a next complex, closing a complex chain, reloading, and/or any other suitable stage, for example as described in more detail with reference to FIG. 5. It will be appreciated that for each different life-cycle stage, the operation management method may include specific code for implementing the required operations. In some embodiments of the present invention, the operation management method is implemented as a software code segment in server application component 96a, for example in coordination component 37.

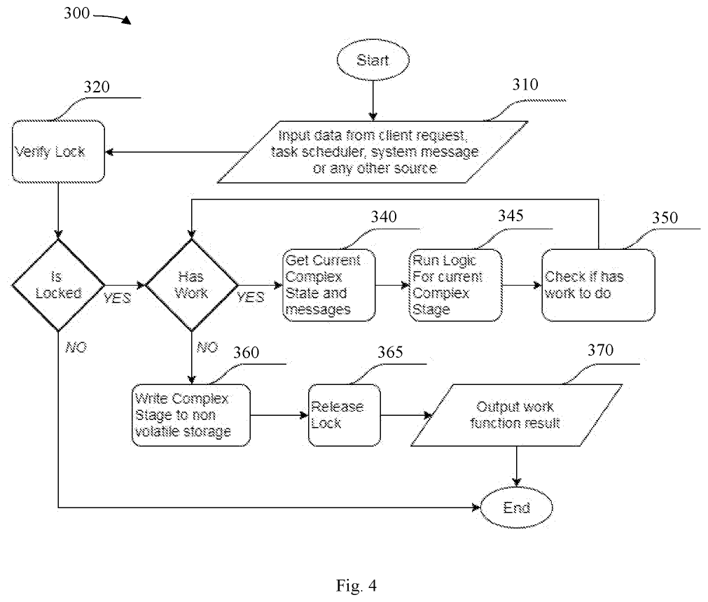

Reference is now made to FIG. 4, which is a schematic illustration of a method 300 for managing operations of complexes 30, according to some embodiments of the present invention. As indicated in block 310, in the beginning of a life-cycle stage of an active complex, application server 96 may check for new input, for example from client application component 94a, task scheduler 37e, message queue 37d, and/or from any other suitable source. New input data may be required for complex 30 to perform tasks and make decisions. Throughout the present description, a complex 30 is said to be at a certain life-cycle stage when complex 30 is in the process of going through the steps of method 300 for this certain stage, and/or until a complex 30 transitions to another stage.

As indicated in block 320, application server 96 may verify that a momentary instance of complex 30 is locked, i.e. certain changes cannot be made to complex 30 by other instances. In some embodiments, application server 96 may first attempt to lock the momentary instance of complex 30, and then check if the instance of complex 30 is locked. In some cases, an error may occur, which may prevent locking of the instance of complex 30. In such cases, As indicated in block 330, the stage cannot proceed, and it ends, as indicated in block 380. In case the instance of complex 30 is locked, as indicated in block 340, application server 96 may obtain and/or identify the current life-cycle stage and/or any input required for performing a required operation. Initially, in the beginning of a stage, complex 30 may have at least the required tasks of initial stage and/or input processing, for example to make sure a life-cycle stage is identified, performed and new input is obtained. As indicated in block 345, application server 96 may run logic of the identified stage, for example, execute a task required at the identified stage. As indicated in block 350, application server 96 may check if complex 30 has additional work in the current stage, e.g. if complex 30 is required to perform additional operation. In case complex 30 has additional work, the steps of obtaining input, identifying a stage and/or running logic of the identified stage may be repeated. The execution of logic operations of the identified life-cycle stage may also be referred to herein as the stage process. During the stage process, parameters of the stage may be embedded in complex 30 and/or changes to parameters of complex 30, which may be referred to herein as stage changes of or made to complex 30. In case complex 30 doesn't have additional work, as indicated in block 360, application server 96 may write stage changes of complex 30 to non-volatile storage 38, for example including parameters that has been changed in this stage and/or during the stage logic execution, for example in order to keep critical changes made to complex 30. In some embodiments, storing the stage changes may include storing identification of the stage itself in relation to the stage changes. In some embodiments of the present invention, application server 96 may decide whether and/or when to write stage changes made to complex 30 into non-volatile storage 38. In some embodiments, in some cases, application server 96 may decide to write at least some of the stage changes to complex cache 37b, for example instead of writing them to non-volatile storage 38. For example, in case the stage changes fulfil at least one predetermined criterion, such as they are irreversible and/or significant or fulfil any other predetermined criterion, such as in case this life-cycle stage of complex 30 is a stage of closing, freezing or creation of complex 30, application server 96 may decide to store at least some of the state data and/or changes made during the complex life-cycle stage to non-volatile storage 38. In case the stage changes do not fulfil the at least one predetermined criterion, application server 96 may decide to store the stage changes to complex cache 37b. This process may prevent excess writing operations to non-volatile 38.

As indicated in block 365, for example after writing the life-cycle stage changes into non-volatile storage 38 and/or to cache 37b, application server 96 may unlock complex 30 to enable processing of other instances of complex 30. As indicated in block 370, application server 96 may output the results and/or products of the logic and/or tasks executed during the stage, for example, the results and/or products may be outputted to client application component 94a, non-volatile storage 38, outputted as a message to message queue 37d or as a task to task queue 37c, implemented in another complex 30 and/or another instance of complex 30, and/or any other suitable use the results and/or products of the stage logic and/or task execution. Then, the stage may end, as indicated in block 380.

Reference is now made to FIG. 5, which is a schematic illustration of an exemplary operation process 400 for a single complex 30 of application structure 200, according to some embodiments of the present invention. According to some embodiments, in each step of process 400, complex 30 goes through a life-cycle stage as described in detail herein.

When complex 30 runs through a certain stage by application server 96 and/or server application component 96a, client application component 94a identifies the same complex 30 as being at the same certain stage. Accordingly, in a certain moment, both server application component 96a and client application component 94a regard complex 30 as being at the same stage. Each block in FIG. 5 may represent another life-cycle stage of complex 30. As indicated in block 410, application server 96, by server application component 96a, may initiate complex 30. Initiation of a complex by application server 96 may include parsing, for example by parser/compiler 37a, code related to and/or ascribed to the complex, for example code generated at and/or received from development server 90, and/or making configurations, for example to adjust complex 30 to certain operation systems and/or devices and/or user preferences and/or requirements.

As indicated in block 420, application server 96 may load data regarding complex 30 from coordination component 37, which in turn may receive information such as messages, commands, instructions, definitions and/or any other suitable information from, for example, storage 38, complex cache 37b, task queue 37c, message queue 37d, task scheduler 37e and/or client application component 94a. Application server 96 may send the loaded information about complex 30 to client application component 94a, as indicated in block 420a. According to some embodiments of the present invention, once application server 96 is done loading and sending information to client application component 94a, server 96 may send component 94a an indication that the loading stage is completed, and/or that complex 30 is ready for rendering by component 94a, by, for example, switching and/or setting complex 30 to a life-cycle stage that enables client component 94a to operate the complex.

As indicated in block 430, for example once receiving an indication from server 96, component 94a may operate the active complex 30, e.g. render and/or run complex 30 on client device 93, for example based on information about complex 30 previously received from server 96. During operation of complex 30, client events and/or commands may be provided by a client user, for example via user interface included in complex 30. Client application component 94a may forward information about operation of complex 30, including, for example, an indication that a client event has occurred and/or a client command has been provided. In some embodiments, during operation of complex 30, client application component 94a may perform operations required by complex 30, by the information received from server 96 and/or by client events and/or commands. As indicated in block 430a, during operation of complex 30, application server 96 may receive from component 94a an indication that a client event has occurred and/or a client command has been provided.

Once an indication about an event and/or command is received from client application component 94a, as indicated in blocks 450 and 450a, application server 96 may upload from client application component 94a information about the client command and/or event and/or any other suitable information about the operation and/or parameters of complex 30. For example, application server 96 may upload from client application component 94a files uploaded to client device 93.

As indicated in block 460, application server 96 may initiate execution of at least one task required by a client command and/or event, and/or required by a parent complex or an external message. The task may be performed for example, by activating business logic 98, as indicated in block 490. Meanwhile, as indicated in block 460a, client application component waits to receive from server 96 results of the at least one performed task and/or report upon completion of the task. As indicated in block 470, once a task is completed, information about complex 30 such as data and/or configurations of complex 30 may be refreshed and then application server 96 may load the refreshed information and/or send it to component 96a, and/or the process repeats from the loading step indicated in block 420.

As indicated in block 472, in some cases, a task requires that complex 30 will be deactivated by server 96, for example when transition is made by server 96 to another complex and/or when a related complex 30 is deactivated. As indicated in block 474, server 96 may re-activate complex 30 when required. After re-activation, information about complex 30 such as data and/or configurations of complex 30 may be refreshed and/or the process may repeat from the refreshing step indicated in block 470.

As indicated in block 480, at some stage, application server 96 may decide and/or may be required to terminate a certain complex 30. For example, a task may require termination of a complex 30. As indicated in block 482, application server 96 may perform terminating operations to terminate complex 30, for example by activating application logic 98, as indicated in block 490. Application server 96 may report to component 94a upon completion of the terminating operation, as indicated in block 460a. As indicated in block 484, after the terminating operations, complex 30 may be terminated, e.g. with no ability to be reloaded. In some embodiments, in some cases, a deactivated complex 30 may be terminated by server 96.

As described herein, according to some embodiments of the present invention, application server 96 activates business logic 98 to perform tasks without involvement of client application component 94a. This enables dealing with tasks at the application server without the need to develop a special procedure in the client application for each different task. Further, it may separate the client user interface from the business logic and thus, for example, provide a more efficient development process, task management, and/or application structure. In some embodiments, when a certain complex 30 is at the stage of performing a task, the parameters and/or results of the task performing stage is written to non-volatile storage 38 in relation to the certain complex 30. Additionally, in some embodiments, a task may be stored in complex cache 37b of the certain complex 30, for example for runtime operations and/or for efficiency of the task operations. For example, server 96 may obtain from cache 37b a state of task execution in order to inform component 94a about this state. For example, the state of a task execution may be obtained from cache 37b in order to enable monitoring, examination and/or displaying of the state. For example, in case of an error, application server 96 may restore the parameters and/or results of the task performing stage from storage 38 and/or cache 37b.

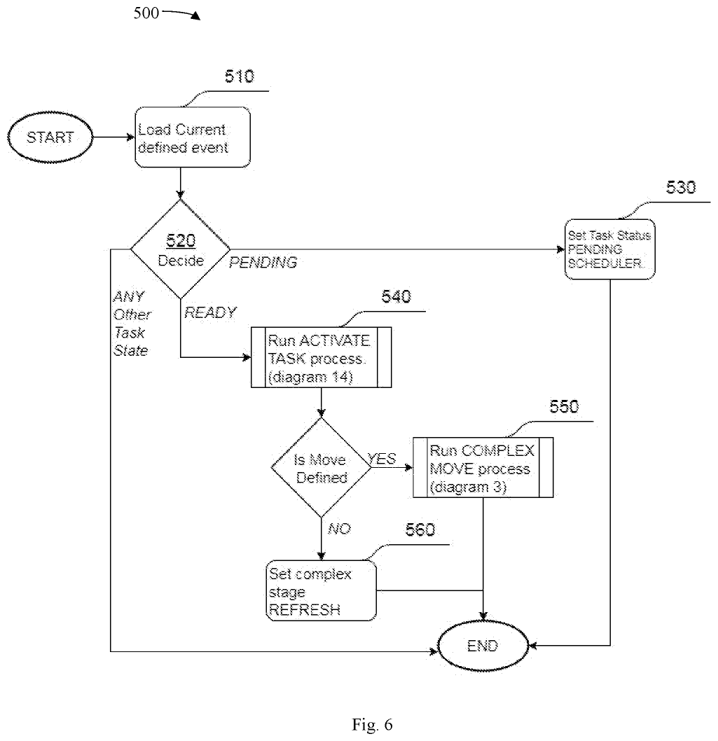

Reference is now made to FIG. 6, which is a schematic illustration of a process 500 for execution of a task, for example following a command received from client application component 94a, for example further to a command and/or event made by a client user, and/or a task required by application logic 98, according to some embodiments of the present invention. As indicated in block 510, application server 96 may load the task definitions and/or data, for example from client application component 94a, from storage 38, and/or from any suitable one or more of coordination sub-components 37a-37d. Based on the received task definitions and/or data, as indicated in block 520, application server 96 may check if the task can be performed as part of the task process, for example promptly and/or within execution process 500 of the task, or the task execution should be delayed. For example, in case a task is irreversible, e.g. if the outcome of performing the task is irreversible, and/or in the expected duration of executing the task is longer than a certain threshold, and/or the task requires using a resource that is not reachable until a later time, application server 96 may postpone the execution of the task. In case the execution is postponed, as indicated in block 530, application server 96 may send the task to task scheduler 37e, which may execute the task at a later time when the conditions fit execution of the task and/or based on any other scheduling considerations. In case the task can be performed promptly, as indicated in block 540, application server 96 activates business logic 98 to perform the task, and/or receive from business logic 98 the results of the task execution. In case the task required transition to another complex 30, as indicated in block 550, application server 96 may deactivate the current active complex 30 that performs the task and transition to another complex 30. In case no transition between complexes is required, as indicated in block 560, application server 96 may refresh information about the active complex 30 such as data and/or configurations, load the refreshed information and/or send it to component 96a, for example with an indication that the task is complete.

According to some embodiments of the present invention, in the beginning of execution of a task, as part of process 500 or a task received from the task scheduler, complex cache 37b and/or storage 38 are updated with information from and/or about the corresponding active complex 30, including, for example, changes made to complex 30 during a certain stage. Therefore, the task is performed with updated complex data and/or definitions, including information about the stage complex 30 is at. At the end of execution of a task, in some embodiments, complex cache 37b and/or storage 38 are updated with information obtained during the execution, for example information received from third entities and/or generated by business logic 98.

As mentioned herein, a group of complexes 30 may be defined, for example by a developer user of development server 90, as constituting a complex chain 32. Chain 32 may consist of complexes 30 that may create together a workflow in client application component 94a, such as submitting a form, generating a report, filing documents, configuring a user account, and/or any other suitable client user process made in the framework of a web application interface. For example, each complex 30 in a certain chain 32 may create a user interface component in component 94a that enables a client user to perform a certain step in the client user process. As mentioned above, for each active chain 32, there may be an active complex 30 currently rendered by client application component 94a, and there may be several non-active complexes 30 preceding the active complex 30 and following the active complex 30 in chain 32. In some embodiments, in a certain chain 32, only a single complex 30 may be active at a certain moment. A chain 32 may include any suitable and/or desired number of complexes 30.

In some embodiments of the present invention, during runtime of an active complex 30, complex cache 37b may include information such as which chain 32 it belongs to and/or which complex 30 preceded it, e.g. was the previous active complex 30 of the same chain 32. Additionally, storage 37a may store in relation to each complex 30 of chain 32 long-term information such as, for example, identification, parameters and/or properties of the respective complex 30, the previous complex 30 and the following complex 30, properties and/or definitions of the transitions between the previous complex 30 and the respective complex 30, and/or between the respective complex 30 and the following complex 30 and/or a list of all the transitions made. For each transition made, storage 37a may store data and/or commands passed in this transition between the previous complex 30 and the respective complex 30 or between the respective complex 30 and the following complex 30, identification, parameters and/or properties of the respective chain 32, an identification of the client user session, and/or any other suitable information related to the transition. Additionally, storage 37a may include information, for example a list or a table, about chains 32 that were active in a certain client user session. Complexes 30 from separate chains 32 may be active concurrently. A client user session may include any suitable number of chains 32.

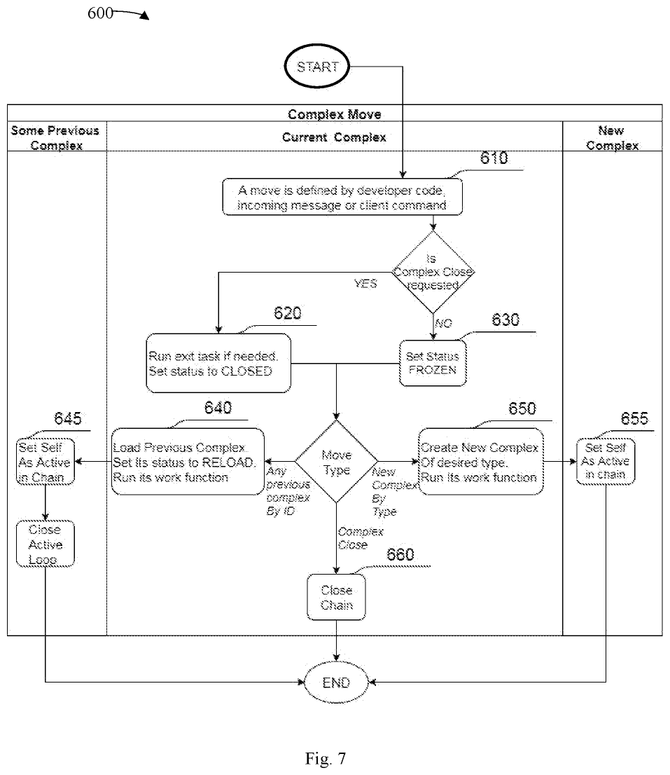

Reference is now made to FIG. 7, which is a schematic illustration of a process 600 for transition between complexes within a chain according to some embodiments of the present invention. A transition may be performed from an active complex 30 to another complex 30, which is made active in the end of the transition. When transition is made, a user interface component created by a previously active complex 30 is replaced with a user interface component created by a currently active complex 30 and presented by component 94a. For example, a display of user details may be replaced with a display of a form, for example to update some of those details. In some embodiments of the present invention, a transition may be made from a current active complex 30 to a previously active complex 30 or to a new complex 30 in chain 32. A transition may be made to a new instance of a previously active complex 30. A transition may be made to a preceding or following complex 30 in chain 32, for example if it was deactivated previously. A transition cannot be made to a terminated complex 30. In some embodiments, in some cases, if the preceding complex 30 in chain 32 is terminated, the transition is made to a next complex 30.

As indicated in block 610, Application server 96 may receive transition instructions from the active complex 30, for example instructions embedded in complex 30 by a developer user, and/or from client application component 94a, for example by client user commands, and/or from application logic 98. For example, application server 96 may check for transition instructions at the end of a task process. In some cases, transition instructions may include an instruction to terminate the currently active complex 30. In other cases, the current active complex 30 is deactivated, thus enabling to return to this complex 30 when needed. In case the transition instructions include instruction to terminate the currently active complex 30, as indicated in block 620, application server 96 may terminate the active complex 30. In some embodiments, in some cases, the instructions to terminate may include instructions to perform an exit task, for example a certain action or a series of actions to be made before terminating complex 30. In such cases server 96 may perform the exit task before terminating complex 30. In case the transition instructions include instruction to terminate the currently active complex 30, as indicated in block 630, application server 96 may deactivate the active complex 30.

The transition instructions may be for transition to previously active complex 30, for transition to a new complex 30, or for terminating chain 32. In case the transition instructions are for transition to a previously active complex 30, the instructions may include an identification of the previously complex 30, and/or the transition is made to the immediately preceding complex 30. As indicated in block 640, the previously active complex 30 to which the transition is made is re-activated by server 96, and information about the now active complex 30 such as data and/or configurations of complex 30 may be refreshed, for example by the life-cycle stage process described in detail herein above with reference to FIG. 4. As indicated in block 645, once re-activated by server 96, data regarding active complex 30 may be loaded into active complex 30, e.g. to datasets related to active complex 30 stored in storage 38 and or cache 37b, for example from coordination component 37 as described in detail herein above. In some embodiments, in some cases, the loaded data may include instructions to server 96 to terminate at least some of the deactivated complexes 30 of the same chain 32, for example as may be required by the transition instructions and/or by instructions embedded in active complex 30, in which case server 96 terminates the at least some of the complexes 30, as requested.

In case the transition instructions are for transition to a new complex 30, the instructions may include an identification and/or definitions as to the type of new active complex 30 to be made, for example the type and/or definitions of the user interface component the complex 30 is required to create. As indicated in block 650, server 96 may load the new active complex 30 based on the identification and/or definitions included in the instructions. As indicated in block 655, once loaded by server 96, data regarding active complex 30 may be loaded into active complex 30, e.g. to datasets related to active complex 30 stored in storage 38 and or cache 37b, for example from coordination component 37 as described in detail herein above. As indicated in block 660, in case the transition instructions are for terminating chain 32, chain 32 may be terminated by server 96 and removed from the complex tree.

Reference is now made to FIG. 8, which is a schematic table 800 of complex trees and complex transition steps, according to some embodiments of the present disclosure. Table 800 shows three exemplary transition steps Step 1, Step 2 and Step 3. The disclosure is not limited to or by these exemplary steps, which are described herein in order to explain features of complex parent-child relations and complex trees, according to some embodiments of the present disclosure. A complex tree 81 may include a hierarchic structure of complexes, including parent and child complexes, as described in more detail herein below. In FIG. 8, complexes are represented by circles. Empty circles represent active complexes. Filled circles represent terminated complexes, and crossed circles represent deactivated complexes. An arrow from one complex to another represent parent-child relations between these two complexes. A double line connecting between two complexes represents that the two complexes are consecutive links of a complex chain.

According to some embodiments of the present disclosure, a complex tree has a single root complex that has no parent complex (e.g. the root complex cannot be a child of another complex). In some embodiments, each complex in a complex tree has at least one parent or child relation to another complex of the complex tree, and a complex cannot be a child of more than one parent complex. In some embodiments, an active complex tree is a complex tree consisting of active complexes. For example, terminated complexes and/or deactivated complexes that are not required for activation and/or or operation of other complexes in the tree may be excluded from an active complex tree.

According to some embodiments of the present disclosure, a parent complex, once changing its life-cycle stage, may send a message to its child complexes about the life-cycle stage change. In response, the child complexes change their life-cycle stages to be the same as the life-cycle stage of the parent. Accordingly, the life-cycle stages of the child complexes may automatically change according to the life-cycle stage of the parent. Additionally, child complexes may receive from the parent complex messages that include other definitions and/or instructions, and may change and/or operate according to the received definitions and/or instructions.

For example, as shown in Step 1, a certain complex c1 may have child complexes such as complexes c2 and c3 (e.g. complex c1 may be a parent complex of complexes c2 and c3), which may be automatically adapted to complex definitions and/or the life-cycle stage from complex c1. A parent complex may include definitions of child complexes. In some embodiments of the present invention, links of a complex chain may be a series of child complexes of a certain parent complex, for example complexes c2 and c6 as shown in Step 2 and Step 3. When a transition is made from a first child complex to a second complex, the second complex may inherit the parent complex of the first complex, e.g. become a child complex of the same parent complex. For example, as shown in Step 2, when a transition is made from complex c2 to complex c6, complex c6 becomes a child complex of complex c1.

According to some embodiments of the present disclosure, the child complexes may be informed by the parent complex and/or the coordination component 37 about its current life-cycle stage, and change the life-cycle stage of the child accordingly. For example, in case a parent complex is terminated or deactivated, its child complexes may also be terminated or deactivated, respectively, for example in response to a message received from the parent complex.

The exemplary active complex tree 81 of Step 1 may include root complex c1. Complexes c2 and c3 are child complexes of complex c1. Complexes c4 and c5 are child complexes of complex c2. In Step 2, a transition is made from complex c2 to another complex of the complex chain, for example complex c6. For example, complex c2 is deactivated and complex c6 is initiated, loaded and/or re-activated. As mentioned above, when a transition is made from complex c2 to complex c6, complex c6 becomes a child complex of complex c1, for example because complex c2 and complex c6 are links of the same complex chain. Once complex c2 is deactivated, its child complexes c4 an c5 inherit the life-cycle stage of the parent complex and thus, for example, complexes c4 and c5 are also deactivated. Once complex c6 becomes active, its child complex c7 may be initiated and/or activated. For example, complex c6 may include definitions of child complex c7 and/or instructions that cause initiation and/or activation of child complex c7 once complex c6 becomes active. Therefore, the exemplary active complex tree 82 of Step 2 includes the active complexes c1, c3, c6 and c7.

In Step 3, a transition is made from complex c6 back to complex c2 of the same chain. For example, complex c6 is terminated and complex c2 is re-activated. In this case, complex c2 remains a child complex of complex c1. Once complex c6 is terminated, its child complex c7 inherit the life-cycle stage of the parent complex and thus, for example, complex c6 is also terminated. Once complex c2 is reactivated, its child complexes c4 and c5 inherit the life-cycle stage of the parent complex and thus, for example, complexes c4 and c5 are also reactivated. Therefore, the exemplary active complex tree 83 of Step 3 includes the active complexes c1, c3, c2, c4 and c5.

As mentioned herein, a message can be transmitted between complexes of the same tree or between complexes of separate trees, wherein the sender complex and/or the recipient complex of the message may be identified by the complex tree the complex is included in and/or the location of the complex inside the complex tree hierarchy.

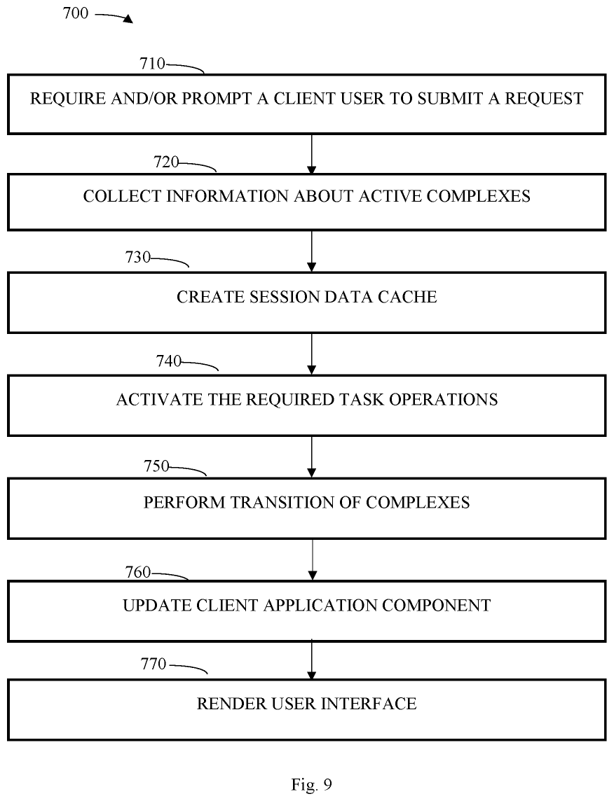

Reference is now made to FIG. 9, which is a schematic illustration of a process 700 for processing of client user requests received by user interface components created by complexes 30 and rendered by client application component 94a, according to some embodiments of the present disclosure.

As indicated in block 710, client application component 94a may require and/or prompt a client user to submit a request, for example by a user interface component created by an active complex 30. For example, the request may be for another complex 30 to be made active or for a new active complex 30. For example, the request may be for activating a certain task performing stage of complex 30. Once the client user submits the required request, as indicated in block 720, client application component 94a may collect information from client data storage 40 about active complexes 30, for example information about changes made to active complexes 30. In some embodiments, in some cases, the request indicates specific complexes 30 for which data should be collected, and then component 94a may collect only information about the indicated active complexes 30. The received request may include one or more required tasks to be performed in connection to active complexes 30. Client application component 94a may sent the collected information and/or instructions included in the client request to server 96.

As indicated in block 730, application server 96 may verify that the session data cache includes information about all active complexes 30 and/or active chains 32. As indicated in block 740, for each active complex 30, application server 96 may activate the required task operations of the respective complex 30, for example as described in detail with reference to FIGS. 4, 5 and 6. As indicated in block 750, in case the instructions received from component 94a and/or a performed task require a complex transition process, application server 96 may perform a transition of complexes 30, for example as described in detail with reference to FIG. 7. As indicated in block 760, server 96 may update client application component 94a with information about active complexes 30, including, for example, the now active complexes 30 and/or their information and/or changes made to active complexes, and/or any other suitable result of the tasks required by the received request. As indicated in block 770, client application component 94a may render the user interface based on the information about active complexes 30 received from server 96.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor, or a portable device such as a smart phone or a tablet computer, or a micro-processor, or a RISC processor, or a DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA or ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

What is claimed is:

1. A system for creating a software application by unified development of both the client side and the backend side, the system comprises:
a server for creating and storing a plurality of self-contained software complexes, each software complex defines a user interface element configured to be rendered at a client device;
a processor configured to execute code instructions stored in the self-contained software complex, and when executed by the processor, the instructions cause the processor to:
activate at least a subset of the plurality of complexes, the activating including sending to a remote client device data from the complexes, the data required for rendering the user interface elements, and initiating a series of life-cycle stage of the complex;
receive from the client device data obtained by the rendered user interface elements; and
update the complexes' life-cycle stages at the server, based on the received data.

2. The system of claim 1, wherein each complex controls its own dataset stored in a storage controlled by the server, and the processor is configured to update the complexes' datasets at the server based on the received data.

3. The system of claim 1, wherein the processor is configured to execute tasks by a business logic based on the data received from the client device.

4. The system of claim 1, wherein at least one of the plurality of complexes is a parent complex including definitions for creation of at least one child complexes.

5. The system of claim 4, wherein the child complexes inherit the life-cycle stage of the parent complex, and change their life-cycle stage according to changes in the life-cycle stage of the parent complex, by a message transmitted to the child complexes via a coordination component in the server.

6. The system of claim 1, wherein at least a subset of the plurality of complexes constitutes a complex chain, wherein the complex chain determines the order of execution of the complexes in the chain.

7. The system of claim 6, wherein, of the complexes in a certain chain, only one is an active complex in a certain moment, wherein an active complex is a complex during the time the corresponding user interface element is rendered at a client device.

8. The system of claim 1, wherein once activating a complex, after initiating, the processor is configured to:
load data about the complex from a coordination component and send the data to the client device;
send to the client device an indication that the loading stage is completed;
switch the complex to a rendering stage that enables the client device to render the corresponding user interface element based on the sent data; and
receive from the client device information gathered during the rendering stage by the corresponding user interface element.

9. The system of claim 8, wherein the processor is configured to deactivate the complex in response to the received information, wherein the data of the complex is kept, and the deactivated complex is re-activatable.

10. The system of claim 8, wherein the processor is configured to terminate the complex in response to the received information, and to send an indication to the client device about the termination.

11. The system of claim 8, wherein the processor is configured to:
initiate execution of a task according to the information gathered during the rendering stage;
refresh data of the complex based on the executed task;
send the refreshed data to the client device;
send to the client device an indication that the loading stage is completed;
switch the complex to a rendering stage that enables the client device to render the corresponding user interface element based on the sent data; and
receive from the client device information gathered during the rendering stage by the corresponding user interface element.

12. The system of claim 11, wherein the processor is configured to:
deactivate the current active complex in case the task required transition to another complex; and
perform transition to another complex.

13. The system of claim 1, wherein the processor is configured to store in a coordination component a message to a recipient complex and to transmit the message to the recipient complex, further to information received during execution of a sender complex, wherein the recipient complex is identified by a complex tree the recipient complex is included in or the location of the recipient complex in a hierarchy of the complex tree.

14. The system of claim 1, wherein the processor is configured to:
receive from the client device a request from a user included in the received obtained data from the rendered user interface element;
perform a task based on the request;
provide the client device with updated information about active complexes required for update of the rendered user interface components by the client device.
